(19) United States
(12) Patent Application Publication
(10) Pub. No.: US 2017/0129763 A1
(43) Pub. Date: May 11, 2017

(54) FLUID TRANSFER DEVICES AND METHODS OF USE

(71) Applicant: ICU Medical, Inc., San Clemente, CA (US)

(72) Inventor: Thomas F. Fangrow, JR., Mission Viejo, CA (US)

(21) Appl. No.: 15/405,722

(22) Filed: Jan. 13, 2017

Related U.S. Application Data
(63) Continuation of application No. PCT/US2015/040174, filed on Jul. 13, 2015.
(60) Provisional application No. 62/024,247, filed on Jul. 14, 2014.

(51) Int. Cl. B67D 7/02; G01F 15/08; B67D 7/76; G01F 15/00; A61J 1/20; A61J 1/10

(52) U.S. Cl. CPC B67D 7/0294; A61J 1/2096; A61J 1/10; A61J 1/2062; A61J 1/2065; A61J 1/2089; B67D 7/763; G01F 15/005; G01F 15/08

(57) ABSTRACT

Some embodiments disclosed herein provide flow path inserts that can redirect flow paths in syringes with axially aligned tips to an outer edge of the syringe. When connected in line with other components, air can become trapped in the system. The syringes can be positioned generally horizontally and air bubbles can be disposed within the body of the syringe. The air bubbles rise to the top or uppermost portion of the syringe. The flow path inserts can facilitate the transfer of the air bubbles disposed within the syringe out the flow path defined by the flow path insert. Some embodiments disclosed herein provide a spinning luer connector for connecting components of a fluidics system.

### RELATED APPLICATIONS

This application claims the benefit under 35 U.S.C. §120 and 35 U.S.C. §365(c) as a continuation of International Application No. PCT/US2015/040174, designating the United States, with an international filing date of Jul. 13, 2015, entitled “Fluid Transfer Devices and Methods of Use,” which claims the benefit of U.S. Provisional Patent Application No. 62/024,247, filed on Jul. 14, 2014, and entitled “Fluid Transfer Devices and Methods Of Use.” The entirety of each of the above-mentioned applications is hereby incorporated by reference herein and made part of this disclosure.

### INCORPORATION BY REFERENCE

U.S. Patent Publication No. 2011/0062703 (the “'703 Publication”), titled “FLUID TRANSFER DEVICES AND METHODS OF USE,” filed on Jul. 28, 2010 as U.S. patent application Ser. No. 12/845,548, and published on Mar. 17, 2011 is hereby incorporated by reference in its entirety and made a part of this specification for all that it discloses.

U.S. Pat. No. 5,685,866 (the “'866 patent”), titled “MEDICAL VALVE AND METHOD OF USE,” filed on Nov. 4, 1994 as U.S. patent application Ser. No. 08/334,846, and granted on Nov. 11, 1997, is hereby incorporated by reference in its entirety and made a part of this specification for all that it discloses.

U.S. Patent Publication No. 2008/0287920 (the “'920 Publication”), titled “MEDICAL CONNECTOR WITH CLOSEABLE MALE LUER,” filed on May 8, 2008 as U.S. patent application Ser. No. 12/117,568, and published on Nov. 20, 2008, is incorporated by reference in its entirety and made a part of this specification for all that it discloses.

U.S. Patent Publication No. 2010/0049157 (the “'157 Publication”), titled “ANTI-REFLUX VIAL ADAPTORS,” filed on Aug. 19, 2009 as U.S. patent application Ser. No. 12/543,776, and published on Feb. 25, 2010, is hereby incorporated by reference in its entirety and made a part of this specification for all that it discloses.

PCT Patent Application No. PCT/US2012/054289, filed Sep. 7, 2012, and titled “MEDICAL CONNECTORS WITH FLUID-RESISTANT MATING INTERFACES,” is hereby incorporated by reference in its entirety and made a part of this specification for all that it discloses.

U.S. Patent Publication No. 2011/0282082 (the “'302 Publication”), titled “MEDICAL CONNECTORS AND METHODS OF USE,” filed on May 12, 2011 as U.S. patent application Ser. No. 13/106,781, and published on Nov. 17, 2011, is hereby incorporated by reference in its entirety and made a part of this specification for all that it discloses.

PCT Patent Application No. PCT/US2012/071493, filed Dec. 21, 2012, and titled “FLUID TRANSFER DEVICES AND METHODS OF USE,” is hereby incorporated by reference in its entirety and made a part of this specification for all that it discloses.

### BACKGROUND

Field of the Invention

Some embodiments of the invention relate generally to devices and methods for transferring fluid and specifically to devices and methods for transferring medical fluids.

Description of the Related Art

In some circumstances, it can be desirable to transfer one or more fluid between containers. In the medical field, it is often desirable to dispense fluid in precise amounts and to store the remainder, particularly when dealing with potentially dangerous fluids. Current fluid transfer devices and methods in the medical field suffer from various drawbacks, including difficulty connecting components of the systems and evacuating air from containers.

### SUMMARY OF SOME EMBODIMENTS

Some embodiments disclosed herein overcome one or more of these disadvantages. In one embodiment, a syringe includes a tubular body wall defining a cavity configured to house a fluid and a plunger positioned at least partially within the cavity. The plunger is configured to move axially within the cavity and along a central axis of the syringe, wherein the movement of the plunger changes the volume of the cavity. The syringe includes a tip extending axially from the syringe body and centered on the central axis of the syringe, wherein a passageway extends axially through the tip. The syringe also includes a flow path insert positioned between the passageway and the cavity, the flow path insert defines a fluid pathway between the cavity and the passageway, and the fluid pathway extends from the passageway to the tubular body wall.

In some embodiments of the flow path insert, the fluid pathway is a groove on a face of the flow path insert extending radially from the center of the flow path insert to the tubular body wall. The flow path insert can form a fluid tight seal between the passageway and the cavity restricting fluid flow between the passageway and the cavity to the fluid pathway. The fluid pathway can be a wedge-shaped groove formed on the flow path insert. The fluid pathway can form a gap between the tubular body wall and the flow path insert. The flow path insert defines a plurality of fluid pathways between the cavity and the passageway. The flow path insert can be circular, oblong or other shapes. The syringe can include indications on the outside of the syringe body indicating a desired orientation of the syringe.

One embodiment of a connector for a fluidics system includes an outer housing and an inner housing. The outer housing includes a base portion, a syringe engagement portion and a first passageway extending through the outer housing. The syringe engagement portion has a plurality of threads configured to engage mating threads on a syringe. The base portion has one or more of retention elements. The inner housing includes a connector portion and a tube portion. The inner housing is positioned within the first passageway of the outer housing. A second passageway extends axially through the inner housing, wherein the tube portion is configured to accommodate a tip of the syringe within the second passageway. The one or more retention elements are configured to position the inner housing within the first passageway, and the outer housing is configured to rotate about the inner housing to engage the mating threads on the syringe.

In some embodiments of the connector, the tube portion includes an inner surface disposed within the second passageway that is configured to form a fluid seal between the tip of the syringe and the inner housing. The tube portion can include tapered walls configured to accommodate the tip of the syringe. The one or more retention elements are retention clips that extend axially into the first passageway and abut an outer surface of the inner housing. The connector portion can be coupled to a fluidics system such that the position of the inner housing is fixed. The second passageway can be in fluid communication with the fluidics system. The syringe engagement portion can include a collar configured to control the position of the syringe relative to the outer housing.

One embodiment of a method for coupling a syringe to a fluidics system includes orienting a syringe with an outer housing of a connector. The position of the connector is fixed and a tip of the syringe is aligned with an axial passageway of the connector. The method further includes coupling the outer housing of the connector with the syringe by rotating the outer housing of the connector about a fixed inner housing of the connector. The outer housing includes a plurality of external threads configured to engage mating threads on the syringe. The method further includes forming a seal between the inner housing and the tip of the syringe by rotating the outer housing until the tip is engaged with the axial passageway of the inner housing. A passageway of the syringe is in fluid communication with a passageway of the inner housing. In some embodiments, the inner housing is fixed to a fluidics system. The syringe can be coupled to the connector without manipulating the orientation of the fluidics system. The syringe can be oriented based on indications on the syringe.

### BRIEF DESCRIPTION OF THE DRAWINGS

FIG. 1 illustrates an example embodiment of an automated system for transferring fluid.

FIG. 2 illustrates an example embodiment of a cross section of syringe with a flow path insert positioned within the body of the syringe.

FIG. 3 illustrates a perspective view of the embodiment of the flow path insert from FIG. 2.

FIG. 4 illustrates a front view of the flow path insert of FIG. 3.

FIG. 5 illustrates a cross section of the flow path insert taken along the line 5-5.

FIG. 6 illustrates another embodiment of a flow path insert.

FIG. 7 illustrates yet another embodiment of a flow path insert.

FIG. 8 illustrates an embodiment of a perspective view of a connector.

FIG. 9 illustrates a different perspective view of the connector from FIG. 8.

FIG. 10A illustrates a cross-section of a perspective view of the connector from FIG. 8.

FIG. 10B illustrates a different perspective view of the same cross-section of the connector from FIG. 8.

FIG. 11 illustrates an exploded view of the connector from FIG. 8.

FIG. 12 provides an exemplary illustration of a connection between a syringe and the connector.

FIG. 13A illustrates is a perspective view of an embodiment of a fluidics assembly.

FIG. 13B is a view of the fluidics assembly 400 with a source container and a target container.

FIG. 14A illustrates a cross sectional view of fluid flowing from a source container to a syringe when the plunger of the syringe is retracted.

FIG. 14B illustrates a cross sectional view of fluid flowing from a syringe to a target container when the plunger of the syringe is advanced.

### DETAILED DESCRIPTION OF SOME EMBODIMENTS

The following detailed description is now directed to example embodiments of the disclosure. In this description, reference is made to the drawings wherein like parts are designated with like numerals throughout the description and drawings.

In many circumstances, fluid is transferred from a source container to a target container. In some instances, it can be desirable to transfer precise amounts of a fluid, such as a medication, into the target container. For example, in some embodiments, a medication can be stored in a vial or other container, and a precise dosage amount of the medication can be extracted and transferred to a target device so that the dosage amount can be delivered to a patient. In some embodiments, fluid from multiple source containers can be combined, or compounded, into a single target container. For example, in some embodiments, a mixture of medications can be created in the target container, or a concentrated medication can be combined with the diluent in the target container. To achieve the desired proportions of fluids, it can be desirable to precisely measure the amount of fluid that is transferred into the target container. In addition, precisely measuring the amount of fluid transferred from the source container to the target container can reduce the amount of fluid wasted (e.g., when more fluid than necessary is withdrawn from the source container). Reduction of waste is desirable because the fluid being transferred can be expensive.

In some embodiments, it can be desirable to transfer fluids from a source container to a target container using a sealed system. Exposing the fluid to ambient air can allow contaminants to enter the fluid or cause an undesirable reaction with the fluid. Some medications (e.g., chemotherapy medications) can be harmful to an unintended recipient. Therefore, it can be desirable to prevent or reduce exposure of the fluid being transferred to the ambient air or area outside the fluid transfer system. A fluid transfer system that prevents or reduces exposure of the fluid to the area outside the fluid transfer system can render other expensive equipment (e.g., a clean room) unnecessary, thereby reducing the cost associated with transferring the fluids.

Some embodiments disclosed herein provide intermediate containers, such as syringes, that facilitate the transfer of fluid from source containers to target containers. When connected in line with other components, air can become trapped in the system. The syringes can be positioned generally horizontally and air bubbles can be disposed within the body of the syringe. The air bubbles rise to the top or uppermost portion of the syringe. When the syringe transfers fluid to the target container, air bubbles disposed within the syringe can remain even after the fluid has been expelled from the syringe as there is a disconnect between the centrally located flow path exiting the syringe and the air bubbles trapped in the body. In some instances, the air bubbles remaining in the syringe may not affect the transfer of fluid, but can be disconcerting to medical practitioners that transfer the medical fluid from the syringe to the target container.

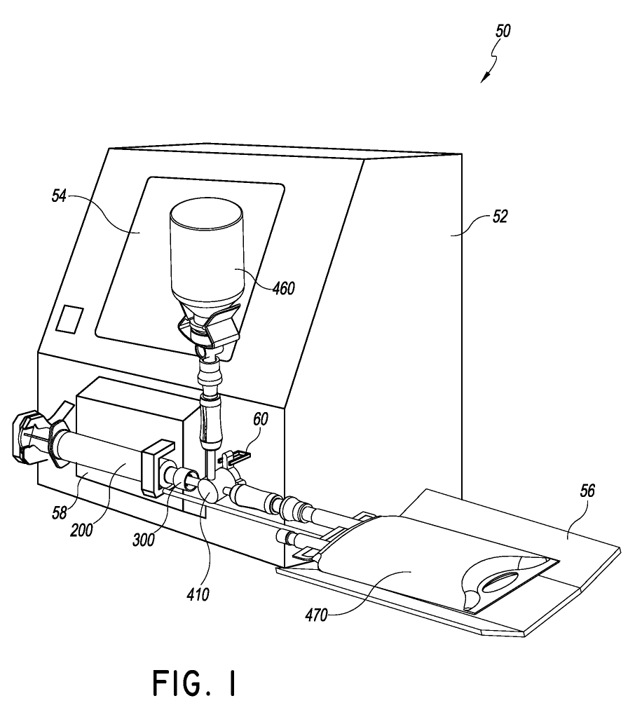

FIG. 1 illustrates an embodiment of a fluid transfer system 50. The system 50 can include a housing 52 enclosing a controller and memory. The system 50 can also include a user interface 54. The user interface 54 can include, for example, a display, a keypad, and/or a touch screen display. The user interface 54 can be configured to receive instructions from the user, for example, regarding the amounts of fluid to be transferred and the types of fluids to be transferred. The user interface can also be configured to provide information to the user, such as error messages, alerts, or instructions (e.g., to replace an empty vial).

The fluid transfer system 50 includes a fluid transfer station. In some embodiments, the system 50 can include multiple transfer stations, such as two, three, four, five, six, seven, eight, or more transfer stations depending on the number of different fluid types the system is designed to handle and the amount of fluid to be transferred. Each transfer station can include a fluid source container 460, which can be, for example, a medical vial or other suitable container such as a bag, a bottle, or a vat, etc. Although embodiments disclosed herein discuss using a vial as the source container, it will be understood the other containers can be used even when not specifically mentioned. The fluid transfer station can be configured to transfer precise amounts of fluid from the source containers 460 to target containers 470, which can be, for example IV bags. It will be understood that in various embodiments described herein, a different type of target container or destination container can be used instead of an IV bag (e.g., a syringe, a bottle, a vial, an elastomeric pump, etc.) even when not specifically mentioned. The fluid transfer station can include a support 56, such as a tray for the target container 470. The support 56 can include a destination sensor, such as a weight sensor to determine the amount of fluid that has been transferred to the target container. The fluid can first be transferred from source containers 460 to intermediate containers 200 so that a precise amount of fluid can be measured. The intermediate containers 200 can be, for example, syringes. After being measured, the fluid can be transferred from intermediate containers 200 to the target containers 470.

The fluid transfer system 50 can be used to transfer individual fluids from the source containers 460 to separate target containers 470, or to transfer and combine fluids from multiple source containers 460 into a common target container 470. In some embodiments, the system 50 can be used for compounding mixtures of fluids. For example, the system 50 can be used to combine multiple medications together or to combine feeding fluids (e.g., water, dextrose, lipids, vitamins, minerals). The system 50 can also be used to dilute a medication or other fluid to a desired concentration level. In some embodiments, a single system can be configured both for compounding mixtures of fluids and for the transfer of individual fluids from a single-source container to a single-target container.

In some embodiments, the system 50 can include mounting modules 58 for mounting the transfer stations onto the housing 52. For example, in some embodiments the mounting modules 58 can be configured to receive intermediate containers 200, as shown in FIG. 1, to secure the transfer stations onto the housing 52. The mounting modules 58 can also engage the connectors or other portions of the fluid transfer station 50. The system 50 can also include motors, which can be for example, contained within the housing 52. The motors can be configured to actuate the intermediate containers 200 to draw fluid into the containers (from the source container 460) and to dispel fluid therefrom (into the target container 470). The motors can be configured to actuate flow control mechanisms 60 in order to control the fluid flow of a connector 410 between the source container 460, intermediate containers 200 and target containers 470. Alternatively, the connector 410 can be manually adjusted to alternate flows. The motors can be in communication with the controller and can receive actuation instructions from the controller. For example, the intermediate containers 200 can operate as precision syringe pumps to transfer precise amounts of fluid with the motors configured in some embodiments to actuate plungers on the syringes to draw fluid into the syringes. The motors and automated system 50 allow for precise transfer of fluids at a faster and more consistent rate than using a syringe pump by hand. For example, a large syringe (e.g., 50 ml or 100 ml) can require significant effort to manipulate the plunger, which can be difficult to perform by hand, especially if done repeatedly. The motors and automated system 50 can increase the precision, consistency and rate of fluid transfer.

In some embodiments, the system includes one or more pairs of male and female fluid connectors configured to be attached to each other to selectively permit the passage of fluid. The connectors can be detached or disconnected, for example, so that the target container 470 can be removed once the fluid has been transferred. In some embodiments, the connectors can be configured to close automatically when disconnected from a corresponding connector, thereby preventing fluid from escaping when the connectors are detached. Thus, the fluid transfer system 50 can be used to transfer fluid while retaining substantially entirely, or entirely, all of the fluid within the system, permitting the fluid transfer to occur in a substantially entirely, or entirely, closed system. The fluid transfer system 50 can thereby reduce or eliminate the risk of injury, waste or damage caused by liquid or vapor leakage when connecting and disconnecting the components of the fluid transfer system 50.

The system 50 can include the connector 300 that is configured to couple the syringe 200 with the other components of the fluidics system. The connector 300 can be a spinning luer connecter that is configured to form a fluid tight engagement with the syringe without disengaging or otherwise changing the orientation of the other fluidics components. The spinning connector 300 can also be used to orient the syringe properly within the mounting module 58. The connector 300 is described in more detail below.

In some embodiments, the system 50 can be configured to be compatible with a variety of sizes of syringes (e.g., 10 ml, 20 ml, 50 ml and 100 ml). For example, larger volume syringes can be used to transfer larger volumes of fluid in shorter amounts of time. Smaller volume syringes can be used to increase the accuracy and precision with which amounts of fluid can be transferred.

The fluid transfer system 50 can be modified in many ways. For example, as mentioned above, the system 50 can have a different number of transfer stations. Also, in some embodiments, certain features shown in the FIG. 1 can be modified or omitted for some or all of the transfer stations. For example, in some embodiments, a fluid transfer station that is dedicated to the transfer of fluids that are not dangerous, expensive, or sensitive to ambient air (e.g., saline or water) can have fewer leak-preventing features than fluid transfer stations dedicated to the transfer of fluids that are dangerous, expensive, or sensitive to ambient air.

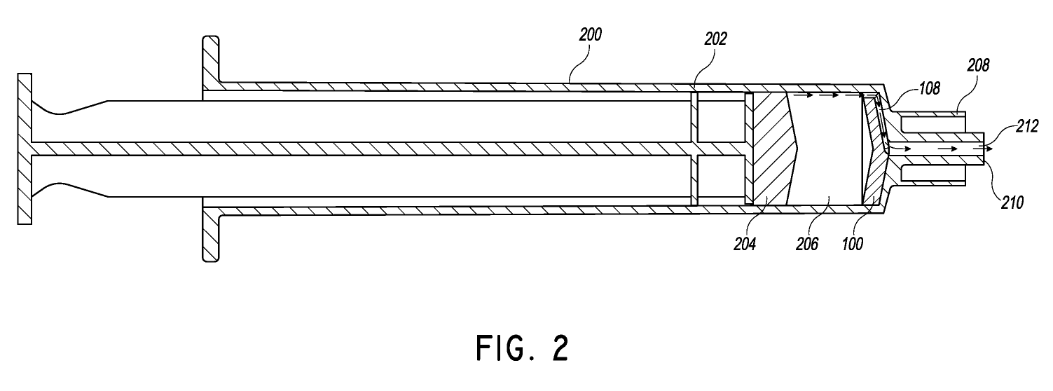

FIGS. 2-5 illustrate an embodiment of a fluid flow path insert 100 for a syringe 200. The flow path insert 100 is configured to redirect fluid flow along a fluid flow path defined by the flow path insert 100. When the syringe is positioned generally horizontally, the syringe can be oriented so that the defined flow path is positioned at or near the top or highest position within the syringe. Gravity causes air bubbles confined within the syringe to rise to the top position within the syringe. By redirecting fluid flow to flow through the top, or near top, position within the syringe, the air bubbles can be forced out of the syringe with the fluid.

FIG. 2 illustrates an embodiment of the flow path insert 100 positioned within the syringe 200. The syringe 200 can include a body 202, a plunger 204, a cavity 206, a shroud 208 and a tip 210. The tip 210 includes a passageway 212 extending axially through the tip 210 that can provide access to the cavity 206 of the syringe 200. The shroud 208 can have inner threads, such as luer threading, on the inner surface for securing a connector, such as connector 300. The engagement can form a fluid-tight connection, such as a luer lock, between the syringe 200 and the connector. In some embodiments, the tip can have threads.

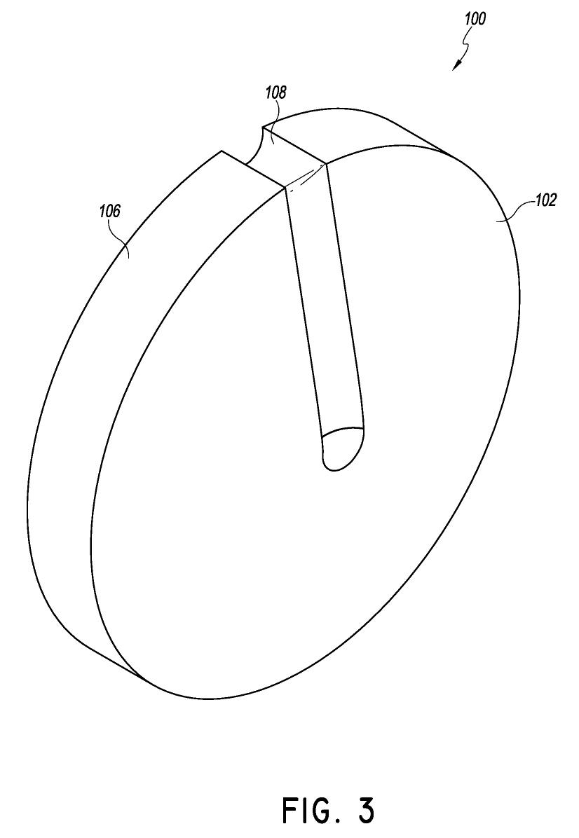

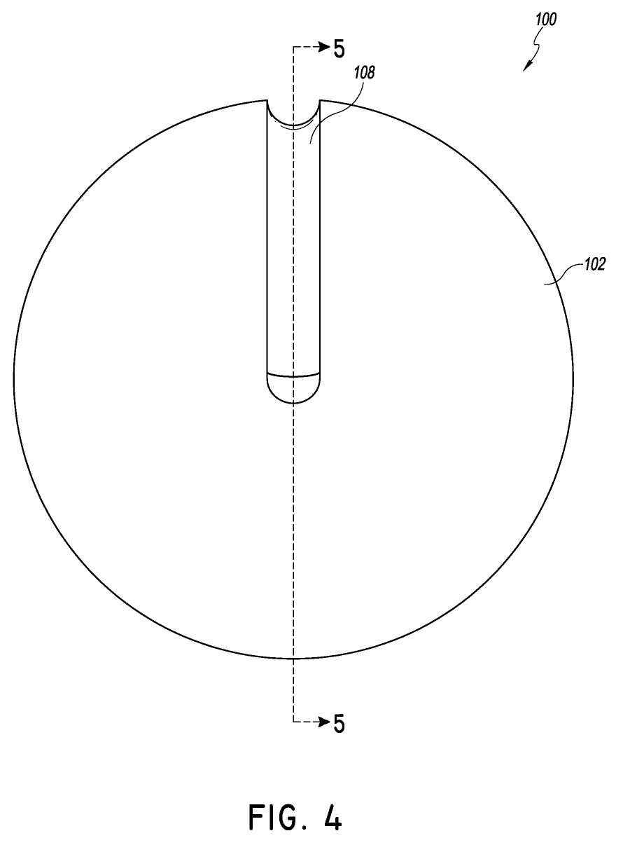

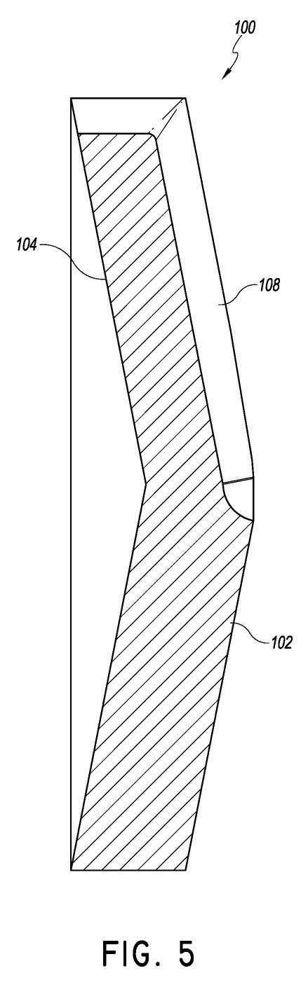

FIG. 3 is a perspective view of the flow path insert 100 removed from the syringe 200. FIG. 4 is a front view of the flow path insert 100. FIG. 5 illustrates a cross section of the flow path insert 100 taken along the line 5-5. The flow path insert 100 has a generally circular body having a first face 102, also referred to as a front face, a second face 104, also referred to as a back face, an outer wall 106 and a pathway 108. The pathway 108 extends radially out from the center of the first face 102 to the outer wall 106 and extends through the first face 102 and the second face 104. The pathway 108 can be formed by removing material from the flow path insert 100, such as by a cutout or a groove. The pathway 108 is configured to define a fluid passageway from the cavity 206 to the passageway 212. The pathway 108 is configured to redirect fluid moving through the syringe 200 to a portion of the inner wall of the syringe 200 prior to or after moving through the passageway 212. The pathway 108 can be sized and shaped so that the syringe 200 has substantially the same flow rate as without the flow path insert 100. The size and shape of the pathway 108 can vary significantly from the embodiment shown while still providing the same functionality.

The flow path insert 100 is sized and shaped to be positioned within the cavity 206 of the syringe 200. The flow path insert 100 can be configured to match the curvature and/or angle of the front wall of the syringe 200, such that the flow path insert is substantially flush with the front wall of the syringe 200. In this embodiment, the outer face 106 of the insert 100 is configured to be flush with the inner wall of the syringe. In this embodiment, the curvature of the insert extends radially from the center of the insert 100 to the outer wall 106 and the first face 102 and the second face 104 have the same curvature. The curvature of the second face 104 can match the curvature and/or angle of the plunger 204. In some embodiments, the flow path insert is not substantially flush with the front wall of the syringe 200. For example, the first face 102 of the flow path insert 100 can be offset from the front wall by one or more protrusions on the flow path insert. The flow path insert 100 can be configured so that it forms a fluid-tight seal between the outer wall 106 and the inner wall of the syringe 200 such that fluid only flows through pathway 108 between the cavity 206 and passageway 212 of the syringe 200.

The flow path insert 100 can be configured for different sizes and types of syringes. The insert can be manufactured from a flexible or compressible material to help facilitate the formation of a fluid seal between the pathway insert 100 and the syringe 200. In some embodiments, the insert 100 can be formed from harder materials.

The flow path insert 100 is configured to define a fluid flow path between the cavity 206 of the syringe. The pathway 108 can direct fluid from the cavity 206 to the tip 210 of the syringe 200. When the syringe is properly oriented, the pathway 108 directs fluid flow along the top of the syringe cavity. By directing the fluid along the top portion of the cavity, the fluid flow can force air bubbles that are enclosed within the cavity 206 of the syringe 200 out of the syringe when the plunger 204 is moved forward. The syringe 200 can include markings, such as arrows, that indicate the orientation of the syringe 200 for correctly positioning the flow path insert 100 within the syringe 200. Alternatively, some methods of installing the insert 100 include aligning the pathway 108 through the outer surface 106 with numbers on the syringe 200.

The flow path insert 100 can be used to modify an existing syringe 200 having a centrally aligned flow path. A method of modifying the syringe 200 can include aligning the flow path insert 100 with the cavity 204 of the syringe 200. The flow path insert 100 can be aligned in accordance with markings that are on the syringe 200 and the position of the pathway 108 on the flow path insert. For example, the syringe can include numbers, letters or markings indicating the proper orientation of the pathway 108 within the syringe. The flow path insert 100 can be inserted within the syringe using an automated process, such as a machine automated process. In some embodiments, the flow path insert 100 can be inserted manually by a worker.

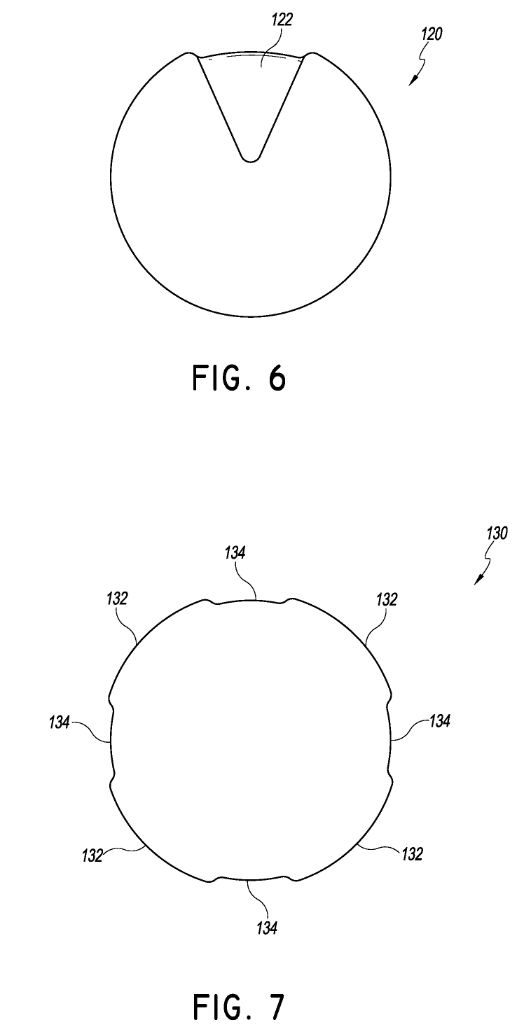

FIG. 6 illustrates another embodiment of a flow path insert 120. In this embodiment, the flow path insert 120 has a wedge-shaped pathway 122. The wedge-shaped pathway 122 provides a larger area for the flow path insert 120 to be positioned within the syringe 200, which can help compensate for errors in positioning of the flow path insert 120 within the syringe 200 and/or inaccurate placement of the syringe in the system 50. The pathway 122 can be configured such that there is a sufficient flow fluid flow rate to force air bubbles out of the syringe with the fluid.

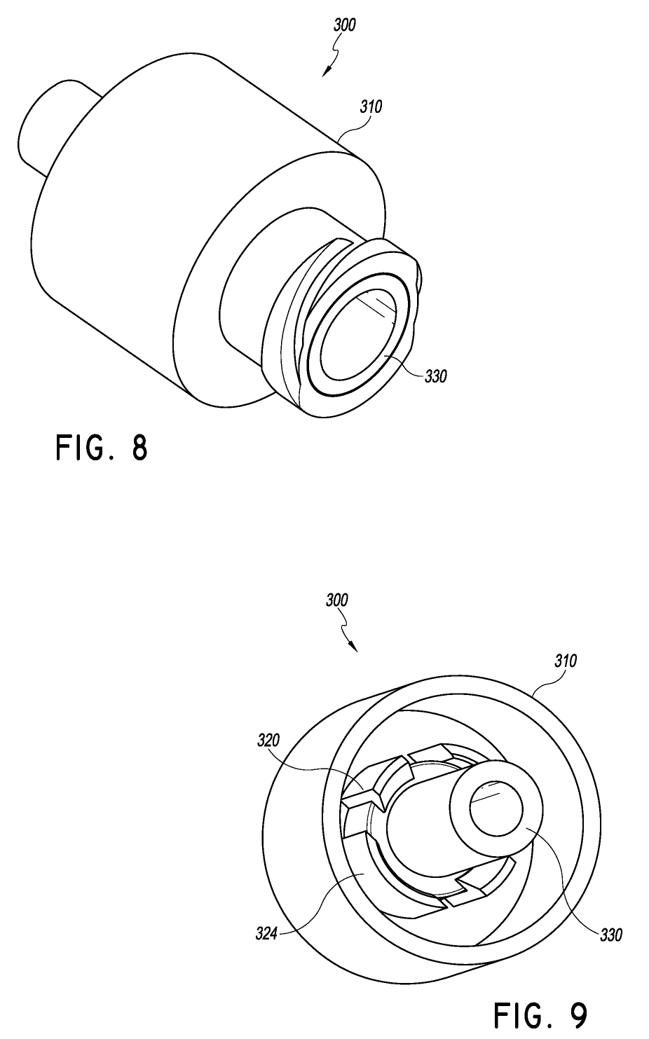

FIG. 7 illustrates another embodiment of a flow path insert 130. In this embodiment, there is a plurality of protrusions 132 that extend radially outward from the flow path insert 130. The protrusions are configured to abut the inner wall of the syringe and force the fluid to be directed along the walls of the syringe 200. In this embodiment the flow path insert 130 can be positioned in nearly any orientation within the syringe and still provide a flow path positioned at the high point of the syringe 200 where a bubble may be likely to occur.

FIGS. 3-7 illustrate a few embodiments of flow path inserts, many different variations exist and are contemplated. In some embodiments, the shape of the pathway can be changed, such as illustrated in FIG. 6. In some embodiments, the shape of the flow path insert can change, such as the embodiment illustrated in FIG. 7. In the embodiments illustrated in FIGS. 2-7, the flow path insert is generally circular. In some embodiments, the flow path insert is not circular. For example, the flow path insert could be oblong, a circle with a cutaway flat portion, rather than a rounded outer wall. The flow path insert and pathway can be shaped in a variety of ways in order redirects fluid flow from the center of the syringe to the outer walls.

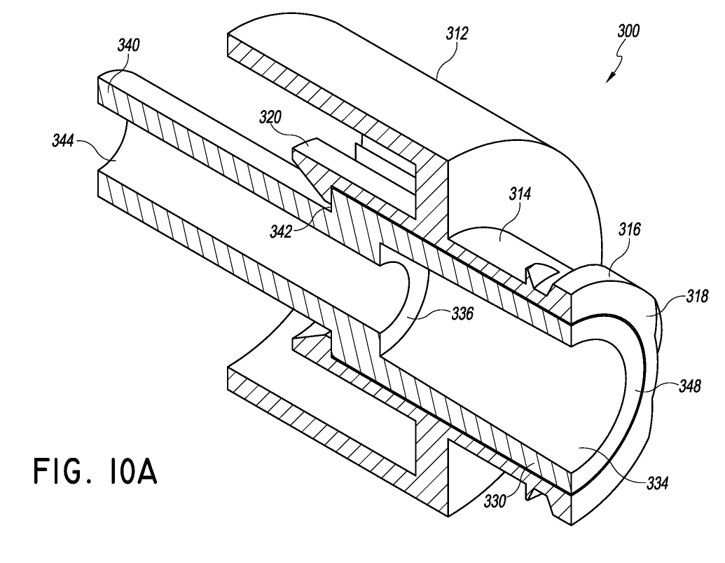

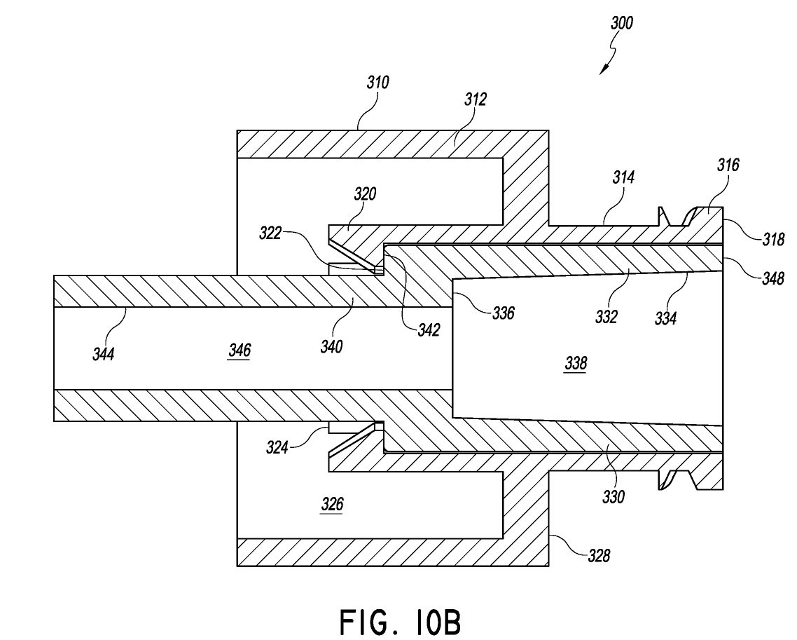

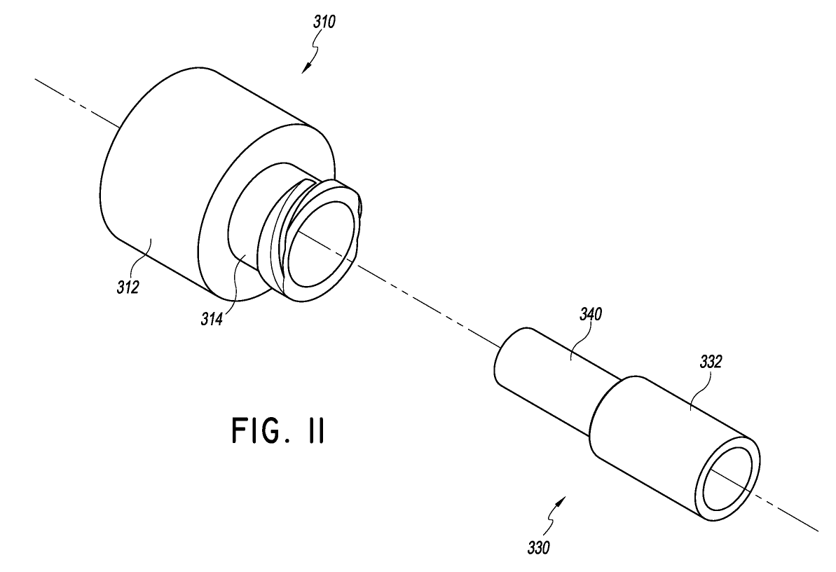

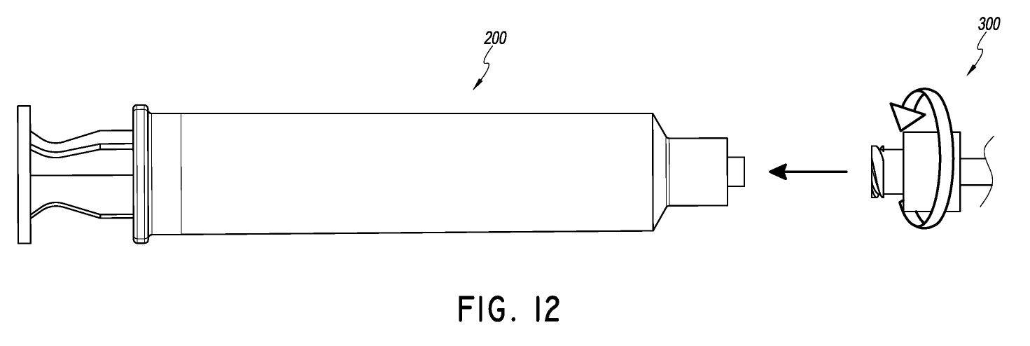

FIGS. 8-11 illustrate an embodiment of a connector 300. FIG. 8 illustrates a perspective view of the connector 300. FIG. 9 illustrates a different perspective view of the connector 300. FIG. 10A illustrates a cross-section of a perspective view of the connector 300. FIG. 10B illustrates a different perspective view of the same cross-section of the connector 300. FIG. 11 illustrates an exploded view of the connector 300.

The connector 300 can include an outer housing 310 and an inner housing 330. The outer housing 310 can be generally tubular in shape and has a passageway that extends axially through the housing 310. The outer housing 310 include a larger diameter portion, also referred to as the base portion 312, and a smaller diameter portion, also referred to as the syringe engagement portion 314. The syringe engagement portion 314 has exterior threads 316 and an outer face 318. The larger diameter portion has a cavity 326. One or more, including a plurality of retention clips 320 and one or more, including a plurality of protrusions 324 are positioned around the cavity for the inner housing 330. The one or more retention clips 320 have clip portions 322 that extend axially inward. The one or more protrusions 324 extend longitudinally. The inner housing 330 is configured to be positioned within the outer housing 310.

The inner housing 330 has a tube portion 332, also referred to as a tip engagement portion, and a connector portion 340. The tube portion 332 has a larger diameter than the connector portion 340. The inner housing 330 has an outer surface 342 and an inner surface 336 and a passageway 346 that extends axially from the distal end of the connector portion 340 to the inner surface 336. The tube portion 332 has a tapered inner wall 334 that tapers down from a larger diameter opening at face 348 to a smaller diameter opening at the inner surface 336.

The inner housing is positioned within the outer housing 310 such that the inner housing 330 can rotate within the outer housing 310. The outer surface 342 of the inner housing is positioned adjacent the retention clip 320. The outer housing 310 and the inner housing 330 can be configured such that face 348 of the inner housing and the face 318 of the outer housing are substantially coplanar when the inner housing 330 is positioned within the outer housing 310. The inner housing 330 is configured to remain stationary and the outer housing 310 is configured to rotate about the inner housing 330. The cavity 338 can be configured to accommodate the syringe tip 210 and form a seal between the inner surface 336 and the syringe tip 210, which can create a fluid tight connection between the syringe 200 and the inner housing 330.

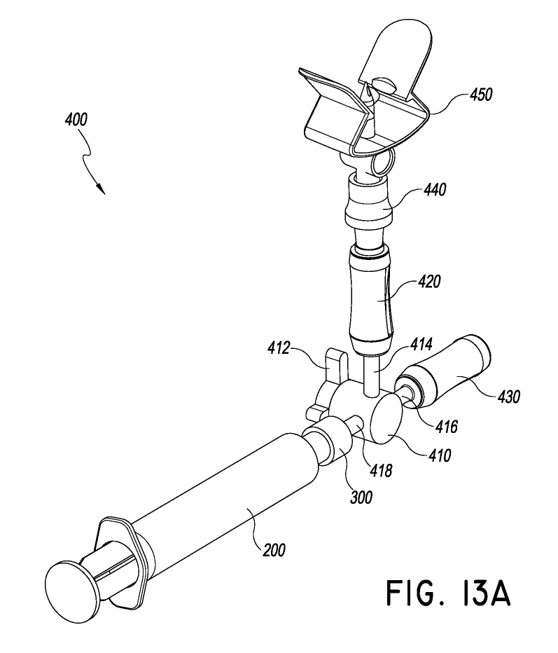

In some embodiments, the connector portion 340 of the inner housing 330 is configured to be coupled to a connector, such as stopcock, of a fluidics system as illustrated in FIG. 12. The outer housing 310 is configured to engage a syringe. For example, the threads 316 can engage threads in the inner wall of the shroud 208 of the syringe 200, which positions the tip 210 of the syringe 200 within the cavity 338 of the inner housing 330. The inner housing 330 remains stationary and the outer housing 310 is configured to rotate about the inner housing 330. As the outer housing 310 rotates and engages the syringe 200, the retention clips 320 maintain the position of the inner housing 330 within the outer housing 310 so that a seal can be formed between the syringe and the inner housing 330. The retention clips 320 preferably permit the outer housing 310 to rotate about the inner housing 330 while maintaining their relative longitudinal positions.

The retention clips 320 allow the connector 300 to be assembled after the connector portion 340 of the inner housing 330 has been secured to another connector, such as connector 410. The outer housing 310 can be positioned onto the inner housing 330 by pushing the outer housing 310 onto the tube portion 332 of the inner housing 330. The retention clips 320 can be forced outward to accommodate the larger diameter of the tube portion 332 as the outer housing 310 is being moved into position. When the outer housing 310 is properly positioned on the inner housing 330, the retention clips can move into position against the outer surface 342 of the inner housing 330, as illustrated in FIG. 10B.

In an alternate embodiment (not shown), the retention clips 320 and longitudinal protrusions 324 can be replaced with a retention portion that extends axially inwardly like the clip portions 322. The retention portion can form an orifice with a constant diameter and have a continuous surface that is configured to abut the outer surface 342 of the inner housing 330. In such an embodiment, the connector 300 is assembled prior to coupling the inner housing 330 to another connector.

The connector 300 can be constructed from a variety of materials, such as polycarbonate or other polymeric materials. The connector 300 can be constructed from a rigid plastic or other rigid polymeric material. In some embodiments, the inner housing can be constructed from a different material than the outer housing. For example, the outer housing could be constructed from a rigid material and the inner housing can be formed from a more flexible material. The flexible material can help from a seal between the syringe and the inner housing 330.

FIG. 12 illustrates a process for connecting the syringe 200 and the connector 300. The syringe interface 314 of the connector 300 is configured to engage the interior threads of shroud 208 of the syringe 200. The outer housing 310 of the connector is configured to rotate to engage the shroud while the tip 210 of the syringe 200 is positioned within the inner housing 330. As the outer housing 310 rotates about the inner housing 330, the tip 210 is positioned within the cavity 338 of the inner housing 330. The connector 300 is configured to form a fluid tight connection between the syringe 200 and the inner housing 330 when the syringe interface is engaged with the syringe. By manipulating the outer housing 310 of the connector 300, the syringe can be engaged with the connector 300 while maintaining a desired orientation where the flow path is positioned in the correct orientation (e.g., with the flow path positioned at the most upward portion of the syringe 200). In some embodiments, the syringe 200 can have markings on the outside of the syringe that indicates the correct orientation of the syringe 200.

In some embodiments, the syringe interface 314 can include a stop mechanism, such as the surface 336 of the inner housing 330, configured to control the position of the syringe 200 relative to the connector 300 when engaged. When the syringe 200 engages the syringe interface 314 of the connector 300, the connector 300 can be configured such that the tip 210 of the syringe 200 abuts against the inner surface 336 of the connector 300 once the syringe 200 is engaged to a desired position. The inner surface 336 can prevent the tip 210 from being over-inserted past the desired engagement position. Other stop mechanisms can be used. For example, the connector 300 can include a collar 328 formed on the syringe interface 314 so that the shroud 208 of the syringe 200 abuts against the collar 328 when the syringe 200 has reached the desired engaged position.

The stop mechanism (e.g., surface 336) can facilitate accurate transfer of fluid. For example, if the syringe 200 were over-inserted past a desired position, an amount of extra fluid may be drawn into the syringe 200 when the plunger is drawn back, thereby compromising the accuracy of the fluid transfer, especially for fluid transfers that involve a volume that require multiple syringe fills. Also, because the internal volume of the fluidics system may be less than the expected internal volume by a small amount if the syringe is over-inserted, priming of the fluidics may result in pushing fluid into an IV bag prematurely.

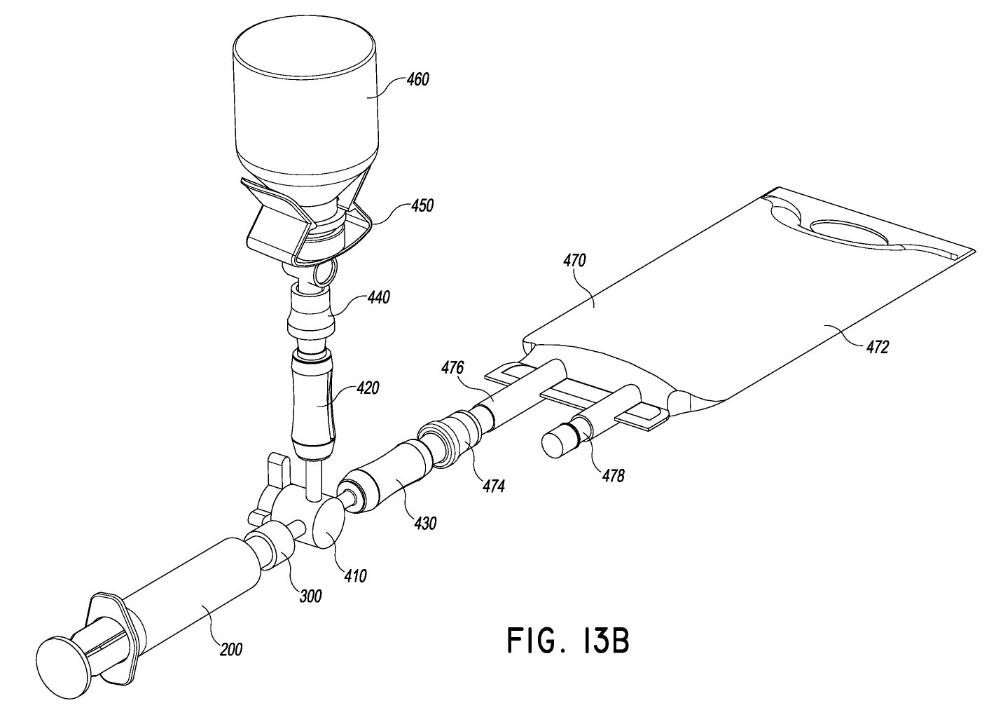

FIG. 13A is a perspective view of a fluidics assembly 400 that can be used with a fluid transfer station, such as the embodiment illustrated in FIG. 1. FIG. 13B is a view of the fluidics assembly 400 with a source container, such as a vial 460, and a target container, such as an IV bag assembly 470 coupled to the assembly 400 of FIG. 13A. The fluidics assembly 400 can be used to transfer precise amounts of fluid from the source container to the target container via an intermediate container, such as a syringe 200. The fluidics assembly 400 includes a vial 460, a vial adapter 450 configured to provide fluid communication with the fluid (e.g., chemotherapy drug or other medication) contained within the vial 460, a syringe 200, an IV bag assembly 470, and a connector 410 for directing fluid from the vial adapter 450 into the syringe 200 and from the syringe 200 toward the IV bag assembly 470. In some embodiments, the fluidics assembly 400 can be configured to allow the vial 460 and/or vial adapter 450 to be replaced (e.g., when the vial runs out of fluid) without replacing the connector 410 or syringe 200. In some embodiments, the vial adapter 450 can be configured to allow air to enter the vial 460 via the vial adapter 450, thereby substantially equalizing pressure in the vial 460 as fluid is drawn out.

The upper portion of the vial adapter 450 can include a spike, as illustrated in FIG. 13A, configured to pierce the septum on the cap of the vial 460 and arms configured to retain the vial 460 onto the vial adapter 450. Opposite the upper portion, the vial adapter can include a connector 440, which can be, for example, a female connector 440. The connector 440 can be, for example, a version of the Clave® connector manufactured by ICU Medical, Inc., of San Clemente, Calif. Various embodiments of a connector of this type are described in the '866 patent. The female connector 440 can seal the end of the vial adapter 450 such that no fluid can escape from the vial adapter 450 until a male connector is attached to the female connector 440. It should be understood that in many embodiments discussed herein, the male and female connectors could be switched. For example, the vial adapter 450 can include a male connector, which is configured to mate with a female connector on the connector 410.

The vial adapter 450 can include an air intake channel configured to direct air into the vial 460 to compensate for fluid removed from the vial 460 to reduce the pressure differential. The air intake channel can include a filter configured to allow air to pass through the filter and toward the vial 460 while also preventing fluid from passing through the filter. For example, the filter can include an air permeable but fluid impermeable membrane. The filter can be a hydrophobic filter. In some embodiments, the vial adapter 450 can include a check valve in place of or in addition to the filter. The check valve could be a duckbill valve, a slit valve, a sliding ball valve or any other suitable type of check valve. The vial adapter 450 can also have a bag that is configured to increase in volume while preventing the input air to contact the fluid inside the vial 460, similar to embodiments described in the '157 Publication.

The IV bag assembly 470 can include an IV bag 472, a length of tubing 476, and a female connector 474. The female connector 474 can be removably or irremovably attached to the tubing 476. The female connector 474 can function to seal off the IV bag assembly 470 so that no fluid can escape from the IV bag 472 except when a male connector is attached thereto. In some embodiments, the IV bag assembly 470 can include a supplemental line of tubing 478 to also provide access to the IV bag 472. The supplemental line 478 can be used to transfer a second fluid (which can be different from the fluid transferred through the main line 476) into the IV bag 472. For example, the tubing 474 can be used to transfer a concentrated fluid (e.g., medication) into the IV bag 472, and the supplemental tubing 478 can be used to transfer a diluent (e.g., saline or water) into the IV bag 472 for diluting the concentrated fluid to a desired level of concentration. In some embodiments, the supplemental line of tubing 478 can have a cap or a connector (not shown), which can be similar to the connector 474, to enable a fluid line to be removably attached to the supplemental line 478. In some embodiments, multiple fluid lines can combine (e.g., at a Y- or T-connection) so that multiple fluids (e.g., from different fluid transfer stations) can be directed into the IV bag 472 through a single fluid line (e.g., tubing 476). In some embodiments, the connector 474 can be directly coupled with the bag 472 without a significant length of tubing 476 therebetween.

The connector 410 can be a connector capable of directing fluid along multiple fluid paths, such as a stopcock. In some embodiments the connector 410 can be manually operated, such as by lever 412 on connector 410. In some embodiments, the connector 410 can be controlled automatically as part of a system, such as in conjunction with a fluid transfer station 50. For example, the fluid transfer station 50 can have a mechanism 60 that controls a valve, switch, lever, or the like, in order to change between a plurality of fluid pathways. A first male connector 420 can be attached to a female end 414 of the connector 410. A second male connector 430 can be attached to a female end 416 of the connector 410.

The male connectors 420, 430 can be closeable male luer connectors that are configured to prevent fluid from escaping from or entering into the connector when it is not engaged with a corresponding female connector, but allow fluid to flow when it is engaged with a corresponding female connector 440, 474. In the embodiments shown, the connectors 420, 430 can be a version of the Spiros® closeable male connector manufactured by ICU Medical, Inc., of San Clemente, Calif. In some embodiments, a substantially entirely or entirely closed system can be achieved, at least in part, by providing corresponding automatically closeable male and female connectors at various (or all) connection points within a fluid transfer system 50, thereby causing stationary fluid to substantially remain entirely within the fluid source, the fluid module, and the fluid target, respectively, upon disconnection, and to not generally leak or vaporize outside of the system. For example, in some embodiments, corresponding pairs of automatically closing connectors (e.g., male and female connectors) can be provided at the interfaces between the fluid source and the connector 410 and/or the connector 410 and the target container. Various embodiments of connectors of this type are described in the '920 Publication.

In this embodiment, and in other embodiments described herein, the system is described as including a male connector or a female connector, it can be possible for female connectors to be used in place of the described male connectors and for male connectors to be used in place of the described female connectors. For example, one or both of the connectors 420 and 430 can be female connectors (e.g., Clave® connectors manufactured by ICU Medical, Inc., of San Clemente, Calif.), and the connector 440 of the vial adapter 450 and the connector 474 of the IV bag 472 can be male connectors (e.g., a Spiros® closeable male connector manufactured by ICU Medical, Inc., of San Clemente, Calif.).

The connector 300 can be attached to a female end 418 of connector 410. The inner housing 330 of the connector is secured, or otherwise affixed to the female end 418 of connector such that it cannot rotate. The inner housing 330 can be secured to the female end 418 of connector 410 by sonic welding, snap fit structures (not shown), a pressure or friction fitting, or other suitable connection type. The outer housing 310 can freely rotate about the inner housing 330. The connector 300 can engage the syringe 200 by rotating the outer housing 310 about the inner housing 330. The outer housing 310 can rotate independent of the fluidics assembly 400. Thereby, the outer housing 310 of the connector 300 can engage to a syringe 200 without moving, rotating, manipulating, or otherwise affecting the orientation of the fluidics assembly 400, which is connected to the inner housing 330.

In some embodiments, the connector 410 can have a mechanical configuration and features that are configured to secure the connector to a fluid transfer station, such as the mechanism illustrated in FIG. 1. Many variations are possible.

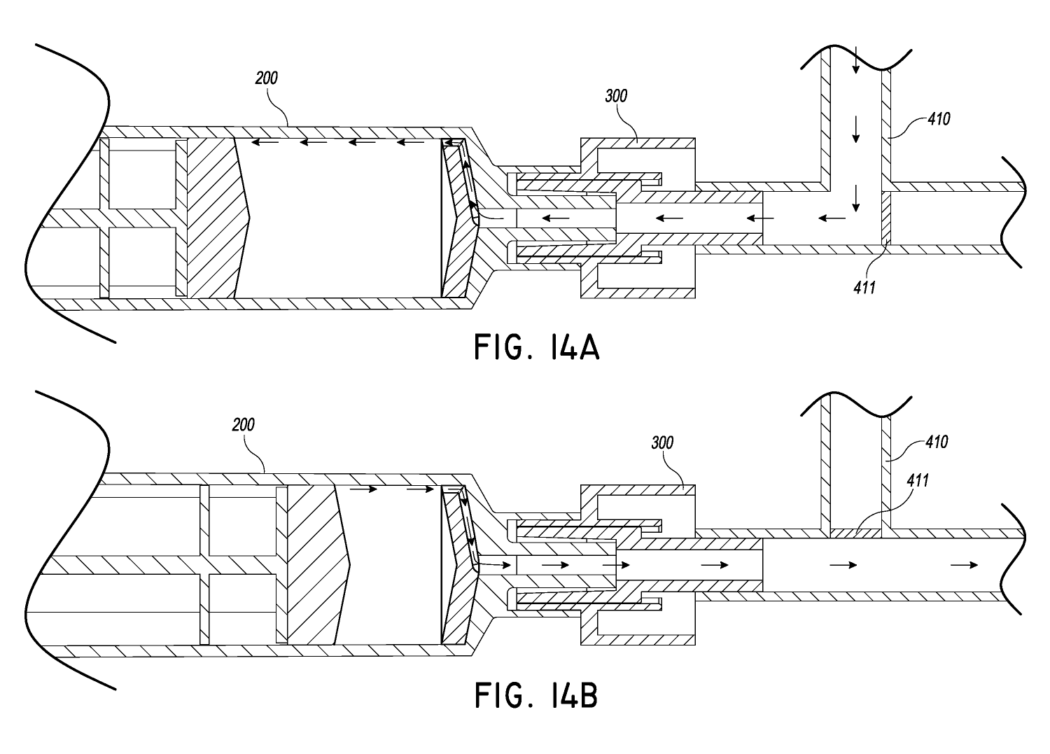

FIG. 14A is a cross sectional view of the syringe 200, the connector 300 and the connector 410 showing fluid flowing through the connector 410 and connector 300 from the vial 460 to the syringe 200. As the plunger of the syringe 200 is withdrawn, fluid is drawn into the syringe 200 and along the flow path defined by the syringe insert 100. In this embodiment, the connector 410 is a connector that has a valve 411 that is positioned so that fluid is allowed to flow from the vial 460 to the syringe 200. In some embodiments, the valve 411 can be positioned by manual manipulation of the lever 412. In some embodiments, the valve 411 can be positioned by an automated mechanism configured to control the actuation of the valve 411. With the valve 411 in the illustrated position, fluid drawn into the syringe 200 will be drawn from the vial 460 and not the IV bag 472. As fluid is drawn out of the vial 460, air can enter the vial 460 through the air intake channel as described above.

FIG. 14B is a cross sectional view of the syringe 200, the connector 300 and the connector 410 showing fluid flowing through the connector 300 and connector 410 from syringe 200 toward the IV bag assembly 370. In this instance, the valve 411 is positioned such that as the plunger of the syringe 200 is advanced, fluid is driven out of the syringe 200. The fluid is allowed to flow from the syringe 200 toward the IV bag assembly 470. Air bubbles can collect in the syringe, which rise to the highest part of the syringe 200. In the illustrated embodiment, the syringe in positioned substantially horizontal. Generally, without the flow path insert 100, the fluid would flow out of the flow path along a central axis of the syringe and the air bubbles would generally remain within the syringe 200. The flow path insert 100 is configured to redirect the fluid flow in order to force the fluid to flow out of the top or near top portion of the syringe 200, thereby forcing the air bubbles out of the syringe 200 with the fluid and along the flow path defined by the flow path insert 100. The syringe 200 can be oriented so that the flow path is positioned in the correct orientation (e.g., with the flow path positioned at the most upward portion of the syringe 200) by manipulating the outer housing 310 of the connector 300. In some embodiments, the syringe 200 can have markings on the outside of the syringe that indicates the correct orientation of the syringe 200. With the valve in the illustrated position, fluid and air bubbles driven out the syringe 200 will be directed to the IV bag 470 and not back into the vial 460.

The following list has example embodiments that are within the scope of this disclosure. The example embodiments that are listed should in no way be interpreted as limiting the scope of the embodiments. Various features of the example embodiments that are listed can be removed, added, or combined to form additional embodiments, which are part of this disclosure:

1. A syringe comprising:
a tubular body wall defining a cavity configured to house a fluid;
a plunger positioned at least partially within the cavity, the plunger configured to move axially within the cavity and along a central axis of the syringe, wherein the movement of the plunger changes the volume of the cavity;
a tip extending axially from the syringe body and centered on the central axis of the syringe, wherein a passageway extends axially through the tip; and
a flow path insert positioned between the passageway and the cavity, wherein the flow path insert defines a fluid pathway between the cavity and the passageway, wherein the fluid pathway extends from the passageway to the tubular body wall.

2. The syringe of embodiment 1, wherein the fluid pathway is a groove on a face of the flow path insert extending radially from the center of the flow path insert to the tubular body wall.

3. The syringe of embodiment 2, wherein the flow path insert forms a fluid tight seal between the passageway and the cavity restricting fluid flow between the passageway and the cavity to the fluid pathway.

4. The syringe of embodiment 1, wherein the fluid pathway is a wedge-shaped groove formed on the flow path insert.

5. The syringe of embodiment 1, where the fluid pathway forms a gap between the tubular body wall and the flow path insert.

6. The syringe of embodiment 1, wherein the flow path insert defines a plurality of fluid pathways between the cavity and the passageway.

7. The syringe of embodiment 1, wherein the flow path insert is circular.

8. The syringe of embodiment 1, wherein the flow path insert is oblong.

9. The syringe of embodiment 1, wherein the syringe includes indications on the outside of the syringe body indicating a desired orientation of the syringe.

10. An apparatus comprising:
an outer housing comprising a base portion and a syringe engagement portion, a first passageway extending through the outer housing, the syringe engagement portion having a plurality of threads configured to engage mating threads on a syringe, the base portion having one or more retention elements; and
an inner housing comprising a connector portion and a tube portion, the inner housing positioned within the first passageway of the outer housing, a second passageway extending axially through the inner housing, wherein the tube portion is configured to accommodate a tip of the syringe within the second passageway;
wherein the one or more retention elements are configured to position the inner housing within the first passageway, and wherein the outer housing is configured to rotate about the inner housing to engage the mating threads on the syringe.

11. The apparatus of embodiment 10, wherein the tube portion further comprises an inner surface disposed within the second passageway, wherein the inner surface is configured to form a fluid seal between the tip of the syringe and the inner housing.

12. The apparatus of embodiment 10, wherein the tube portion comprises tapered walls configured to accommodate the tip of the syringe.

13. The apparatus of embodiment 10, wherein the plurality of retention elements are retention clips that extend axially into the first passageway and abut an outer surface of the inner housing.

14. The apparatus of embodiment 10, wherein the connector portion is coupled to a fluidics system such that the position of the inner housing is fixed.

15. The apparatus of embodiment 14, wherein the second passageway is in fluid communication with the fluidics system.

16. The apparatus of embodiment 10, wherein the syringe engagement portion further comprises a collar configured to control the position of the syringe relative to the outer housing.

17. A method comprising:
orienting a syringe with an outer housing of a connector, wherein the position of the connector is fixed, wherein a tip of the syringe is aligned with an axial passageway of the connector;
coupling the outer housing of the connector with the syringe by rotating the outer housing of the connector about a fixed inner housing of the connector, wherein the outer housing comprises a plurality of external threads configured to engage mating threads on the syringe; and
forming a seal between the inner housing and the tip of the syringe by rotating the outer housing until the tip is engaged with the axial passageway of the inner housing, wherein a passageway of the syringe is in fluid communication with a passageway of the inner housing.

18. The method of embodiment 17, wherein the inner housing is fixed to a fluidics system.

19. The method of embodiment 18, wherein the syringe is coupled to the connector without manipulating the orientation of the fluidics system.

20. The method of embodiment 17, wherein orienting the syringe comprises orienting the syringe based on indications on the syringe.

Embodiments have been described in connection with the accompanying drawings. However, it should be understood that the foregoing embodiments have been described at a level of detail to allow one of ordinary skill in the art to make and use the devices, systems, etc. described herein. A wide variety of variation is possible. Components, elements, and/or steps may be altered, added, removed, or rearranged. Additionally, processing steps may be added, removed or reordered. While certain embodiments have been explicitly described, other embodiments will also be apparent to those of ordinary skill in the art based on this disclosure.

Some aspects of the systems and methods described herein can advantageously be implemented using, for example, computer software, hardware, firmware or any combination of software, hardware and firmware. Software can comprise computer executable code for performing the functions described herein. In some embodiments, computer-executable code is executed by one or more general-purpose computers. However, a skilled artisan will appreciate, in light of this disclosure, that any module that can be implemented using software to be executed on a general purpose computer can also be implemented using a different combination of hardware, software, or firmware. For example, such a module can be implemented completely in hardware using a combination of integrated circuits. Alternatively or additionally, such a module can be implemented completely or partially using specialized computers designed to perform the particular functions described herein rather than by general purpose computers.

While certain embodiments have been explicitly described, other embodiments will become apparent to those of ordinary skill in the art based on this disclosure. Therefore, the scope of the invention is intended to be defined by reference to the claims as ultimately published in one or more publications or issued in one or more patents and not simply with regard to the explicitly described embodiments.

The following is claimed:

1. A fluidics assembly configured to be used with an automated system for transferring medical fluid, the fluidics assembly comprising:
a first fluid connector comprising a male or female fluid connector, the first fluid connector being configured to be attachable in fluid communication with a fluid source container;
a second fluid connector comprising a male or female fluid connector, the second fluid connector configured to be attachable in fluid communication with a fluid target container;
an intermediate container; and
a connector with a valve configured to change between a plurality of fluid pathways, including a first fluid pathway configured to flow from the fluid source container to the intermediate container, and a second fluid pathway configured to flow from the intermediate container to the fluid target container;
wherein the connector is configured to be secured to the automated system and the valve is configured to be positioned between the plurality of fluid pathways by an automated mechanism of the automated system for transferring medical fluid.

2. The combination of the fluidics assembly of claim 1 and the automated system for transferring medical fluid.

3. The combination of the fluidics assembly of claim 1 and the fluid source container.

4. The combination of claim 3, wherein the fluid source container is a vial.

5. The combination of the fluidics assembly of claim 1 and the fluid target container.

6. The combination of claim 5, wherein the fluid target container is an IV bag.

7. The combination of the fluidics assembly of claim 1 and the fluid source container and the fluid target container, in which the fluid source container is a vial and the fluid target container is an IV bag.

8. The fluidics assembly of claim 1, wherein the first fluid connector is a male fluid connector.

9. The fluidics assembly of claim 3, wherein the second fluid connector is a female fluid connector.

10. The fluidics assembly of claim 1, wherein the intermediate container is a syringe.

11. A medical fluid transfer system comprising:
a fluid transfer station comprising a display and a keypad; and
a fluidics assembly configured to be secured to the fluid transfer station, the fluidics assembly comprising a plurality of male or female connectors, a syringe, and a connector with a valve;
wherein the fluid transfer station is configured to automatically control the connector with the valve to change between a pathway from a source container to a syringe and a pathway from the syringe toward a destination container.

12. The fluid transfer system of claim 11 further comprising the source container.

13. The fluid transfer system of claim 11 further comprising the destination container.

14. The fluid transfer system of claim 11 in which the plurality of male or female connectors includes a plurality of closable male fluid connectors.

15. A method of enabling the transfer of medical fluid comprising:
providing a fluid transfer station with a display and a keypad; and
providing a fluidics assembly configured to be secured to the fluid transfer station, the fluidics assembly comprising first and second male or female connectors attached to a connector comprising a valve;
wherein the fluid transfer station is configured to automatically control the connector with the valve to change between a plurality of pathways.

16. The method of claim 15, wherein the plurality of pathways includes a pathway from a source container to an intermediate container.

17. The method of claim 16, wherein the plurality of pathways includes a pathway from the intermediate container to a target container.

18. The method of claim 17, wherein the source container is a vial.

19. The method of claim 18, wherein the intermediate container is a syringe.

20. The method of claim 19, wherein the target container is an IV bag.
